(19) United States
(12) Patent Application Publication
(10) Pub. No.: US 2017/0081620 A1
(43) Pub. Date: Mar. 23, 2017

(54) PROCESS FOR MAKING A DETERGENT COMPOSITION

(71) Applicant: The Procter & Gamble Company, Cincinnati, OH (US)

(72) Inventors: Ritu KATAKY, Durham (GB); Chifundo Nyasha Michelle NTOLA, Durham (GB); Mauro VACCARO, Newcastle upon Tyne (GB); Anju Deepali Massey BROOKER, Newcastle upon Tyne (GB); Melissa CUTHBERTSON, Tyne & Wear (GB); Stephen John WALKER, Northumberland (GB)

(21) Appl. No.: 15/263,470

(22) Filed: Sep. 13, 2016

(30) Foreign Application Priority Data
Sep. 17, 2015 (EP) 15185687.9

(51) Int. Cl. C11D 11/00; C11D 1/29; C11D 3/37; C11D 3/50; C11D 1/22; C11D 17/00; C11D 17/04; C11D 1/66; C11D 17/06

(52) U.S. Cl. CPC C11D 11/0017; C11D 1/66; C11D 1/29; C11D 3/373; C11D 17/06; C11D 1/22; C11D 17/0013; C11D 17/045; C11D 17/042; C11D 3/50; C11D 3/3742

(57) ABSTRACT

The present invention relates to a detergent composition comprising a core-shell particle, wherein the core-shell particle comprises a core, wherein the core comprises at least 50% by weight of the core of a mixture of silicone and fatty acid, wherein the core-shell particle comprise a shell, wherein the shell comprises at least 66% by weight of the shell of a polymer.

### FIELD OF THE INVENTION

The present invention relates to detergent compositions comprising a core-shell particle. The core shell particle comprises silicone and fatty acid and provides a detergent composition that exhibits good stability profile, both physical stability and chemical stability.

### BACKGROUND OF THE INVENTION

Hydrophobic oily benefit agents such as silicone, are incorporated into a variety of compositions, such as detergent products. In some applications, such as laundry treatment, it is desirable for these hydrophobic oily benefit agents to be delivered onto the surface to be treated during the treatment process. However, hydrophobic oily benefit agents are typically incorporated into these consumer goods products at very low levels, and the efficiency of silicone deposition onto the treated surface during the treatment process is also low. Compatibility with other detergent ingredients is also a problem, especially in highly alkaline environments and/or in highly aqueous environments.

Incorporating hydrophobic oily benefit agents such as silicones into detergent compositions is difficult. Silicones are highly viscous materials and difficult to handle and incorporate. Furthermore, the compatibility profile of these materials with other ingredients, such as detergent ingredients needs to be improved, especially in highly alkaline environments and/or highly aqueous environments.

The Inventors have found that a detergent composition according to the present invention overcomes these problems.

EP1479378 relates to a personal product compositions comprising structured benefit agent premix or delivery vehicle and providing enhanced effect of hydrophobic material separate from the structured benefit agent. This invention comprises a structured premix or “delivery vehicle” composition designed as a carrier to enhance the benefit (e.g., via enhanced deposition or other mechanism) of a separate hydrophobic benefit agent(s) (for example, perfumes, skin lightening agents, etc.), from personal product compositions (e.g., liquid and bar cleansers, creams, emulsions, hair composition, deodorant etc.). When the structured benefit agent composition is separately prepared and combined with the personal product composition (preferably while structured, premix composition is still in molten or liquid state), the personal product composition with structured benefit agent carrier provides enhanced deposition of the structured benefit agent and enhanced effect of the separate hydrophobic benefit agent(s) in or on the carrier or in the presence of structured benefit agent carrier.

WO2012089474 relates to a method for production of an emulsion. This invention has as an objective to provide a new emulsification method, which can produce concentrated water-continuous emulsion containing lipophilic compounds in a dispersed phase, with a very fine dispersed phase droplet size less than a micron, and a narrow size distribution of the dispersed phase. This objective has been met by a method wherein a water-continuous emulsion is made using a Controlled Deformation Dynamic Mixer or a Cavity Transfer Mixer.

WO2011116962 relates to a process of treatment of fibers and/or textile materials. This invention covers a process of treatment of textile materials containing microcapsules of active ingredients, the fibers and/or textile materials resulting from this process and their cosmetic or pharmaceutical use and/or their use as a repellent.

### SUMMARY OF THE INVENTION

The present invention relates to a detergent composition comprising a core-shell particle, wherein the core-shell particle comprises a core, wherein the core comprises at least 50% by weight of the core of a mixture of silicone and fatty acid, wherein the core-shell particle comprise a shell, wherein the shell comprises at least 66% by weight of the shell of a polymer.

### DETAILED DESCRIPTION OF THE INVENTION

Detergent Composition:

The detergent composition comprises a core-shell particle, wherein the core-shell particle comprises a core, wherein the core comprises at least 50% by weight of the core of a mixture of silicone and fatty amphiphile, wherein the core-shell particle comprise a shell, wherein the shell comprises at least 66% by weight of the shell of a polymer. It may be preferred that the core-shell particle comprises from 90 wt % to 98 wt % by weight of the particle of core and from 2 wt % to 10 wt % by weight of the particle of shell.

Preferably, the composition comprises the weight ratio of fatty amphiphile to silicone present in the core in the range of from 5:1 to 15:1.

Preferably, the composition is a core-shell particle which comprises at least 10% by weight of the core of detersive surfactant.

Typically, the detergent composition comprises other ingredients. These detergent ingredients are described in more detail below.

The composition may be a laundry detergent powder. Typically, the laundry detergent powder comprises from 3 wt % to 30 wt % core-shell particle and from 33 wt % to 97 wt % detergent particle, and optionally wherein the detergent particle comprises a polymer which has the same chemical structure as the polymer comprised in the shell of the core-shell particle.

The composition may be a liquid laundry detergent composition. Typically, the liquid laundry detergent composition comprises from 3 wt % to 10 wt % core-shell particle and from 90 wt % to 97 wt % liquid detergent matrix, wherein the core-shell particle is suspended within a continuous phase of liquid detergent matrix, and wherein the liquid detergent matrix comprises at least 1% by weight of the liquid detergent matrix of a polymer which has the same chemical structure as the polymer comprised in the shell of the core-shell particle, and optionally wherein the liquid detergent matrix comprises less than 30% by weight of the liquid detergent matrix of water.

The composition may be a water-soluble unit dose laundry detergent pouch.

Preferably, the laundry detergent pouch comprising at least two separate compartments, wherein the first compartment comprises the core-shell particle, and wherein the first compartment has a pH in the range of from 3.0 to 7.0, and wherein the second compartment comprises a detergent ingredient, and wherein the second compartment has a pH in the range of from greater than 7.0 to 12.0.

Preferably, the first compartment has a pH in the range of from 4.0 to 6.0, and wherein the second compartment has a pH in the range of from greater than 7.0 to 11.0.

Preferably, the first compartment comprises from 15% to 25% by weight of the core surfactant and from 2% to 5% of the polymer present in the first compartment, of the core-shell particle, and wherein the second compartment comprises from 15% to 35% of surfactant, from 50% to 70% of fatty amphiphile and polymer coating from 2% to 10% by weight of ingredients present in the second compartment.

Core-Shell Particle:

The core-shell particle comprises a core, wherein the core comprises at least 50% by weight of the core of a mixture of silicone and fatty amphiphile, wherein the core-shell particle comprise a shell, wherein the shell comprises at least 66% by weight of the shell of a polymer. It may be preferred for the core-shell particle to comprise from 90 wt % to 98 wt % by weight of the particle of core and from 2 wt % to 10 wt % by weight of the particle of shell. Preferably, the weight ratio of fatty acid to silicone present in the core is in the range of from 5:1 to 15:1.

Preferably, the core-shell particle comprises at least 10% by weight of the core of detersive surfactant. Preferably, the detersive surfactant is selected from alkyl benzene sulphonate, alkyl alkoxylated alcohol, alkyl alkoxylated sulphate, polyoxyethylene sorbitan monooleate and any combination thereof. More preferably, the detersive surfactant is a C₁₂-C₁₆ alkyl ethoxylated alcohol having an average degree of ethoxylation of from 3 to 7.

Preferably, the core comprises at least 5% by weight of the core of perfume.

Silicone:

Suitable silicones are selected from the group consisting of cyclic silicones, polydimethylsiloxanes, aminosilicones, cationic silicones, silicone polyethers, silicone resins, silicone urethanes, and mixtures thereof.

A preferred silicone is a polydialkylsilicone, alternatively a polydimethyl silicone (polydimethyl siloxane or “PDMS”), or a derivative thereof.

Preferably, the silicone has a viscosity at a temperature of 25° C. and a shear rate of 1000 s⁻¹ in the range of from 10 Pa s to 100 Pa s. Without wishing to be bound by theory, increasing the viscosity of the silicone improves the deposition of the perfume onto the treated surface. However, without wishing to be bound by theory, if the viscosity is too high, it is difficult to process and form the Detergent composition. A preferred silicone is AK 60000 from Wacker, Munich, Germany

Other suitable silicones are selected from an aminofunctional silicone, amino-polyether silicone, alkyloxylated silicone, cationic silicone, ethoxylated silicone, propoxylated silicone, ethoxylated/propoxylated silicone, quaternary silicone, or combinations thereof.

Suitable silicones are selected from random or blocky organosilicone polymers having the following formula:

[R₁R₂R₃SiO_{1/2}]₍ⱼ₊₂₎[(R₄Si(X—Z)O_{2/2}]ₖ[R₄R₄SiO_{2/2}]ₘ[R₄SiO_{3/2}]ⱼ
wherein:
   j is an integer from 0 to about 98; in one aspect j is an integer from 0 to about 48; in one aspect, j is 0;
   k is an integer from 0 to about 200, in one aspect k is an integer from 0 to about 50; when k=0, at least one of R₁, R₂ or R₃ is —X—Z;
   m is an integer from 4 to about 5,000; in one aspect m is an integer from about 10 to about 4,000; in another aspect m is an integer from about 50 to about 2,000;
      R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X—Z;
      each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
      each X in said alkyl siloxane polymer comprises a substituted or unsubstituted divalent alkylene radical comprising 2-12 carbon atoms, in one aspect each divalent alkylene radical is independently selected from the group consisting of —(CH₂)ₛ— wherein s is an integer from about 2 to about 8, from about 2 to about 4; in one aspect, each X in said alkyl siloxane polymer comprises a substituted divalent alkylene radical selected from the group consisting of: —CH₂—CH(OH)—CH₂—; —CH₂—CH₂—CH(OH)—; and

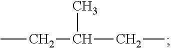

each Z is selected independently from the group consisting of

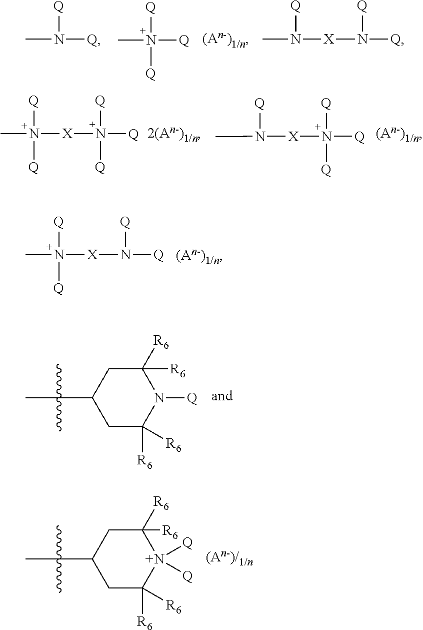

with the proviso that when Z is a quat, Q cannot be an amide, imine, or urea moiety and if Q is an amide, imine, or urea moiety, then any additional Q bonded to the same nitrogen as said amide, imine, or urea moiety must be H or a C₁-C₆ alkyl, in one aspect, said additional Q is H;
for Z Aⁿ⁻ is a suitable charge balancing anion. In one aspect Aⁿ⁻ is selected from the group consisting of Cl⁻, Br⁻, I⁻, methylsulfate, toluene sulfonate, carboxylate and phosphate; and at least one Q in said organosilicone is independently selected from —CH₂—CH(OH)—CH₂—R₅;

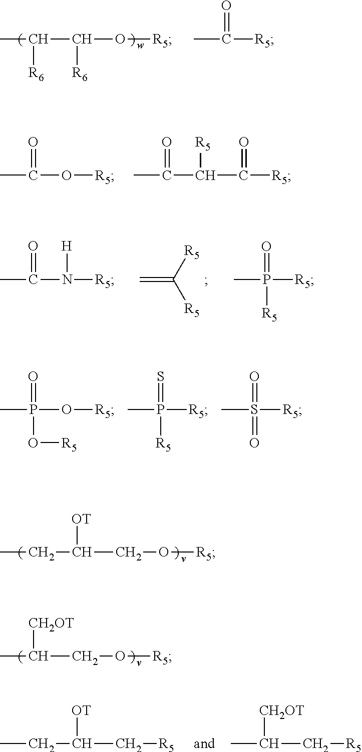

each additional Q in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —CH₂—CH(OH)—CH₂—R₅;

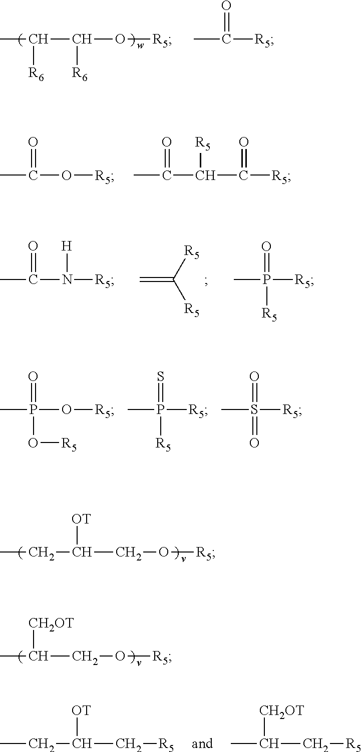

wherein each R₅ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR₆—CHR₆—O—)_{w}-L and a siloxyl residue;
each R₆ is independently selected from H, C₁-C₁₈ alkyl
each L is independently selected from —C(O)—R₇ or R₇;
w is an integer from 0 to about 500, in one aspect w is an integer from about 1 to about 200; in one aspect w is an integer from about 1 to about 50;
each R₇ is selected independently from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl; C₆-C₃₂ substituted alkylaryl and a siloxyl residue;
each T is independently selected from H, and

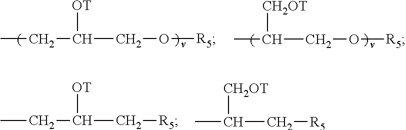

and
wherein each v in said organosilicone is an integer from 1 to about 10, in one aspect, v is an integer from 1 to about 5 and the sum of all v indices in each Q in the said organosilicone is an integer from 1 to about 30 or from 1 to about 20 or even from 1 to about 10.

In another embodiment, the silicone may be chosen from a random or blocky organosilicone polymer having the following formula:

[R₁R₂R₃SiO_{1/2}]₍ⱼ₊₂₎[(R₄Si(X—Z)O_{2/2}]ₖ[R₄R₄SiO_{2/2}]ₘ[R₄SiO_{3/2}]ⱼ

wherein
j is an integer from 0 to about 98; in one aspect j is an integer from 0 to about 48; in one aspect, j is 0;
k is an integer from 0 to about 200; when k=0, at least one of R₁, R₂ or R₃=—X—Z, in one aspect, k is an integer from 0 to about 50
m is an integer from 4 to about 5,000; in one aspect m is an integer from about 10 to about 4,000; in another aspect m is an integer from about 50 to about 2,000;
R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X—Z;
each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
each X comprises of a substituted or unsubstituted divalent alkylene radical comprising 2-12 carbon atoms; in one aspect each X is independently selected from the group consisting of —(CH₂)ₛ—O—; —CH₂—CH(OH)—CH₂—O—;

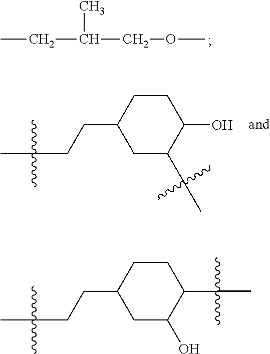

wherein each s independently is an integer from about 2 to about 8, in one aspect s is an integer from about 2 to about 4;

At least one Z in the said organosiloxane is selected from the group consisting of R₅;

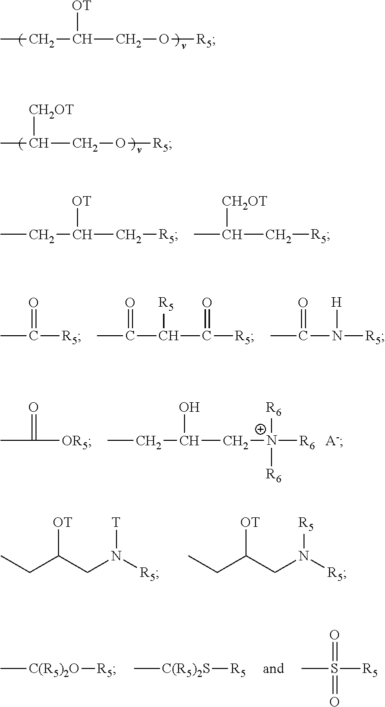

provided that when X is

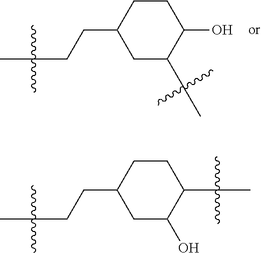 [SMILES: *CCC1CCC(O)C(*)C1 ; *CCC1CCC(*)C(O)C1]

then Z=—OR₅ or

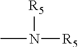

wherein A⁻ is a suitable charge balancing anion. In one aspect A⁻ is selected from the group consisting of Cl⁻, Br⁻,
I⁻, methylsulfate, toluene sulfonate, carboxylate and phosphate and each additional Z in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, R₅,

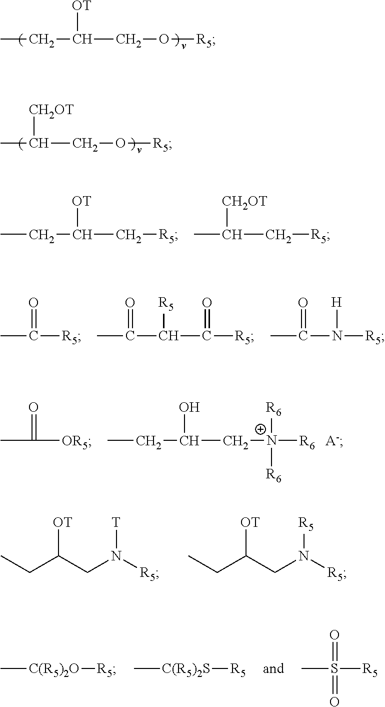

provided that when X is

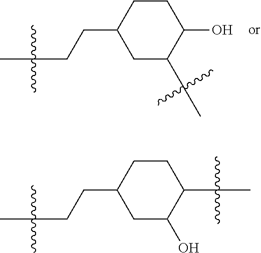 [SMILES: *CCC1CCC(O)C(*)C1 ; *CCC1CCC(*)C(O)C1]

then Z=—OR₅ or

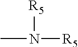

each R₅ is independently selected from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl,
—(CHR₆—CHR₆—O—)_{w}—CHR₆—CHR₆-L and siloxyl residue wherein each L is independently selected from —O—C(O)—R₇ or —O—R₇;

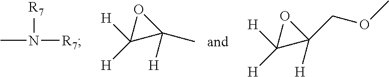

w is an integer from 0 to about 500, in one aspect w is an integer from 0 to about 200, one aspect w is an integer from 0 to about 50;
each R₆ is independently selected from H or C₁-C₁₈ alkyl;
each R₇ is independently selected from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted aryl, and a siloxyl residue;
each T is independently selected from H;

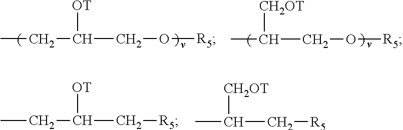

wherein each v in said organosilicone is an integer from 1 to about 10, in one aspect, v is an integer from 1 to about 5 and the sum of all v indices in each Z in the said organosilicone is an integer from 1 to about 30 or from 1 to about 20 or even from 1 to about 10.

A suitable silicone is a blocky cationic organopolysiloxane having the formula:

M_{w}DₓT_{y}Q_{z}

wherein:
M=[SiR₁R₂R₃O_{1/2}], [SiR₁R₂G₁O_{1/2}], [SiR₁G₁G₂O_{1/2}], [SiG₁G₂G₃O_{1/2}], or combinations thereof;
D=[SiR₁R₂O_{2/2}], [SiR₁G₁O_{2/2}], [SiG₁G₂O_{2/2}] or combinations thereof;
T=[SiR₁O_{3/2}], [SiG₁O_{3/2}] or combinations thereof;

### Q=[SiO_{4/2}];

w=is an integer from 1 to (2+y+2z);
x=is an integer from 5 to 15,000;
y=is an integer from 0 to 98;
z=is an integer from 0 to 98;
R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy, C₁-C₃₂ alkylamino, and C₁-C₃₂ substituted alkylamino;
at least one of M, D, or T incorporates at least one moiety G₁, G₂ or G₃, and G₁, G₂, and G₃ are each independently selected from the formula:

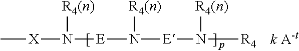

wherein:
X comprises a divalent radical selected from the group consisting of C₁-C₃₂ alkylene, C₁-C₃₂ substituted alkylene, C₅-C₃₂ or C₆-C₃₂ arylene, C₅-C₃₂ or C₆-C₃₂ substituted arylene, C₆-C₃₂ arylalkylene, C₆-C₃₂ substituted arylalkylene, C₁-C₃₂ alkoxy, C₁-C₃₂ substituted alkoxy, C₁-C₃₂ alkyleneamino, C₁-C₃₂ substituted alkyleneamino, ring-opened epoxide, and ring-opened glycidyl, with the proviso that if X does not comprise a repeating alkylene oxide moiety then X can further comprise a heteroatom selected from the group consisting of P, N and O;
each R₄ comprises identical or different monovalent radicals selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted alkylaryl;
E comprises a divalent radical selected from the group consisting of C₁-C₃₂ alkylene, C₁-C₃₂ substituted alkylene, C₅-C₃₂ or C₆-C₃₂ arylene, C₅-C₃₂ or C₆-C₃₂ substituted arylene, C₆-C₃₂ arylalkylene, C₆-C₃₂ substituted arylalkylene, C₁-C₃₂ alkoxy, C₁-C₃₂ substituted alkoxy, C₁-C₃₂ alkyleneamino, C₁-C₃₂ substituted alkyleneamino, ring-opened epoxide and ring-opened glycidyl, with the proviso that if E does not comprise a repeating alkylene oxide moiety then E can further comprise a heteroatom selected from the group consisting of P, N, and 0;
E′ comprises a divalent radical selected from the group consisting of C₁-C₃₂ alkylene, C₁-C₃₂ substituted alkylene, C₅-C₃₂ or C₆-C₃₂ arylene, C₅-C₃₂ or C₆-C₃₂ substituted arylene, C₆-C₃₂ arylalkylene, C₆-C₃₂ substituted arylalkylene, C₁-C₃₂ alkoxy, C₁-C₃₂ substituted alkoxy, C₁-C₃₂ alkyleneamino, C₁-C₃₂ substituted alkyleneamino, ring-opened epoxide and ring-opened glycidyl, with the proviso that if E′ does not comprise a repeating alkylene oxide moiety then E′ can further comprise a heteroatom selected from the group consisting of P, N, and O;
p is an integer independently selected from 1 to 50;
n is an integer independently selected from 1 or 2;
when at least one of G₁, G₂, or G₃ is positively charged, A^{-t} is a suitable charge balancing anion or anions such that the total charge, k, of the charge-balancing anion or anions is equal to and opposite from the net charge on the moiety G₁, G₂ or G₃, wherein t is an integer independently selected from 1, 2, or 3; and k≦(p*2/t)+1; such that the total number of cationic charges balances the total number of anionic charges in the organopolysiloxane molecule;
and wherein at least one E does not comprise an ethylene moiety.

Preferably, the silicone has a structure selected from:

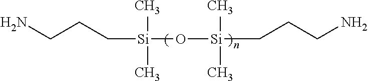

wherein n is in the range of from 200 to 300;
or

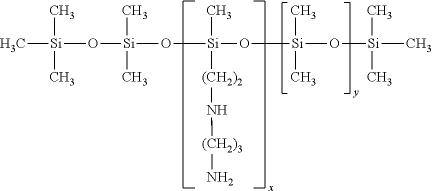

wherein X is from 1 to 5, and wherein Y is from 200 to 700.

Fatty Acid:

Preferably, the fatty acid is C₁₀-C₁₆ alkyl fatty acid. Preferably, the fatty acid has a melting point of at least 40° C., more preferably at least 50° C. or even at least 60° C.

Preferably, the fatty acid has a pKa in the range of from 6 to 8.

Polymer:

A suitable polymer is an alkoxylated polyethylene imine polymer having a weight average molecular weight in the range of from 300 Da to 1,000 Da, and wherein the polymer comprises an ethoxy and/or propoxy chain having from 12 to 36 alkoxy moieties.

Other suitable polymers are selected from polyethylene glycol and derivatives thereof, polyethyleneimine and derivatives thereof, polyvinyl pyrolidone and derivatives thereof, polyvinyl alcohol and derivatives thereof, cellulosic polymer, and any combination thereof.

Another suitable polymer has the structure

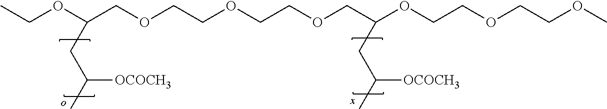

Other Ingredients:

The Detergent composition may comprise other ingredients. Suitable ingredients are selected from petrolatum and/or sensate. Suitable sensates are compounds that provide a cooling, warming, tingling or refreshing sensation, either through the endothermic or exothermic processes of physical lowering or raising of temperature; or through the physiological cooling process associated with, e.g., cold menthol receptor (TRPM8), or any other receptors generally located at or near nerve endings. Suitable sensates include menthol and derivatives thereof. Suitable menthol derivatives include menthyl lactate (available under the trade name Frescolat ML from Symrise GmbH & Co., Holzminden, Germany), menthol with a carboxamide derivative, menthol with a cyclohexanecarboxamide derivative, dimethyl menthyl succinimide, menthone glycerin acetal (available under the trade name Frescolat MGA from Symrise GmbH & Co., Holzminden, Germany), menthoxypropanediol (commercially available under the trade name Coolact 10 and Coolact P (−)-isopulegol from Takasago Int'l Corp., Tokyo, Japan); neoisomenthol, neomenthol, isomenthol, PMD 38 p-menthane-3,8,-diol, (2R)-3-(1-menthoxy)propane-1,2-diol, (2RS)-3-(1-menthoxy)propane-1,2-diol; N-ethyl-p-menthane-3-carboxamide (WS-3), ethyleneglycol p-menthane-3-carboxylate (WS-4), ethyl 3-(p-menthane-3-carboxamido)acetate (WS-5), N-(4-methoxyphenyl)-p-menthane-3-carboxamide (WS-12), N-t-butyl-p-menthane-carboxamide (WS-14), 2-isopropyl-N-2,3-trimethylbutyramide (WS-23), 1-glyceryl p-menthane-3-carboxylate (WS-30) (all commercially available from Millennium Chemicals, Hunt Valley, Md., USA). Other suitable sensates include phenol derivatives, such as thymol and eugenol, Icilin (Phoenix Pharmaceuticals, Belmont, Calif., USA), 2(5H)-MPF (Nestec, Vevey, Switzerland), 4-methyl-3-(1-pyrrolidinyl)2[5H]-furanone, MPD vanillyl acetal (Takasago Int'l Corp., Tokyo, Japan) Hotact VBE (Lipo Chemicals, Inc., Paterson, N.J., USA) and capsaicin (derivative of cayenne pepper).

Surfactant:

Suitable surfactants include anionic surfactants, non-ionic surfactants, zwitterionic surfactants and amphoteric surfactants.

Suitable anionic detersive surfactants include sulphate and sulphonate detersive surfactants. Suitable sulphonate detersive surfactants include alkyl benzene sulphonate, such as C₁₀₋₁₃ alkyl benzene sulphonate. Suitable alkyl benzene sulphonate (LAS) is obtainable, or even obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. Another suitable anionic detersive surfactant is alkyl benzene sulphonate that is obtained by DETAL catalyzed process, although other synthesis routes, such as HF, may also be suitable.

Suitable sulphate detersive surfactants include alkyl sulphate, such as C₈₋₁₈ alkyl sulphate, or predominantly C₁₂ alkyl sulphate. The alkyl sulphate may be derived from natural sources, such as coco and/or tallow. Alternative, the alkyl sulphate may be derived from synthetic sources such as C₁₂₋₁₅ alkyl sulphate.

Another suitable sulphate detersive surfactant is alkyl alkoxylated sulphate, such as alkyl ethoxylated sulphate, or a C₈₋₁₈ alkyl alkoxylated sulphate, or a C₈₋₁₈ alkyl ethoxylated sulphate. The alkyl alkoxylated sulphate may have an average degree of alkoxylation of from 0.5 to 20, or from 0.5 to 10. The alkyl alkoxylated sulphate may be a C₈₋₁₈ alkyl ethoxylated sulphate, typically having an average degree of ethoxylation of from 0.5 to 10, or from 0.5 to 7, or from 0.5 to 5 or from 0.5 to 3.

The alkyl sulphate, alkyl alkoxylated sulphate and alkyl benzene sulphonates may be linear or branched, substituted or un-substituted.

The anionic detersive surfactant may be a mid-chain branched anionic detersive surfactant, such as a mid-chain branched alkyl sulphate and/or a mid-chain branched alkyl benzene sulphonate. The mid-chain branches are typically C₁₋₄ alkyl groups, such as methyl and/or ethyl groups.

Another suitable anionic detersive surfactant is alkyl ethoxy carboxylate.

The anionic detersive surfactants are typically present in their salt form, typically being complexed with a suitable cation. Suitable counter-ions include Na⁺ and K⁺.

Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein optionally the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols; C₁₄-C₂₂ mid-chain branched alkyl alkoxylates, typically having an average degree of alkoxylation of from 1 to 30; alkylpolysaccharides, such as alkylpolyglycosides; polyhydroxy fatty acid amides; ether capped poly(oxyalkylated) alcohol surfactants; and mixtures thereof. Suitable nonionic detersive surfactants include secondary alcohol-based detersive surfactants. Other suitable non-ionic detersive surfactants include EO/PO block co-polymer surfactants, such as the Plurafac® series of surfactants available from BASF, and sugar-derived surfactants such as alkyl N-methyl glucose amide.

Preferred surfactants include alkyl benzene sulphonate, alkyl ethoxylated sulphate, and mixtures thereof. Preferred surfactants include C₁₀-C₁₃ alkyl benzene sulphonate, C₁₂-C₁₅ alkyl ethoxylated sulphate having an average degree of ethoxylation in the range of from 1.0 to 5.0 and mixtures thereof. Preferably the surfactant is an anionic surfactant having a cationic counter-ion selected from sodium or calcium. Preferably, the surfactant has a HLB in the range of from 30 to

[symbol]

Process for Making a Detergent Composition:

The process comprises the steps of:

(a) contacting a silicone with molten fatty acid to form a mixture of silicone and fatty acid;
(b) optionally, contacting the silicone with a detersive surfactant and/or perfume; and
(c) coating this mixture with a polymer to form a core-shell particle; and
(d) incorporating the core-shell particle formed in step (c) into a detergent composition.
Preferably, the silicone is contacted with perfume prior to contacting the silicone with fatty acid.
Preferably, the core is extruded prior to coating step (c).
Preferably, the fatty acid is cooled to a temperature below its melting point prior to step (c).

Step (a):

The fatty acid and the silicone may be contacted at a temperature of at least 40° C., or even at least 70° C. Preferred heating means include hot water jacketing and/or hot oil jacketing. Other heating means include direct heat, electrical tracing, steam heating.

Suitable equipment for contacting the silicone to the fatty acid include mixers such as DPM range of high torque mixers from Charles Ross & Son Company, Hauppauge, N.Y.

Preferably, step (a) is carried out at a pH in the range of from 4.0 to 7.0, more preferably from 5.0 to 6.0. Preferably, step (a) is carried out at a pH that corresponds to, or is similar to, the pKa of the fatty acid. More preferably, step (a) is carried out at a pH no greater than 0.5 pH units above the pKa of the fatty acid, and no less than 0.5 pH units below the pKa of the fatty acid.

Optional Step (b).

Preferably, during this optional step (b), the mixture goes through a pressurized gun to form a solid particle.

Step (c).

Preferably, the mixture is sprayed with a polymer. This can be carried out in a spray-drying tower.

Application of the Detergent Composition:

The detergent composition can be incorporated into a variety of products, such as laundry detergent products, dish-washing detergent products, hard surface cleaning products, fabric enhancer products.

C log P:

The log P values of many perfume materials have been reported; for example, the Pomona92 database, available from Daylight Chemical Information Systems, Inc. (Daylight CIS, Irvine, Calif.), contains many, along with citations to the original literature. However, the log P values are most conveniently calculated by the “C LOG P” program, also available from Daylight CIS. The “calculated log P” (C log P) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990). The fragment approach is based on the chemical structure of each perfume ingredient, and takes into account the numbers and types of atoms, the atom connectivity, and chemical bonding.

Boiling Point:

The boiling point of perfume material is measured according to standard test method ASTM D2887-04a, “Standard Test Method for Boiling Range Distribution of Petroleum Fractions by Gas Chromatography,” (ASTM International, West Conshohocken, Pa., USA″.

Melting Point:

The Melting Point value is determined using the widely used standard Differential Scanning calorimetry methodology described in the following published article: “Comprehensive Evaluation of the Melting Points of Fatty Acids and Esters Determined by Differential Scanning calorimetry”. J. Am. Oil Chem. Soc. (2009). 86:843-856A.

pKa:

The pKa value is the negative log (base 10) of the acid dissociation constant. The acid dissociation constant, Kₐ, is the equilibrium constant for the acid-base dissociation reaction. The equilibrium of acid dissociation can be written symbolically as:

HA⇄A⁻+H⁺

where HA is a generic acid that dissociates by splitting into A⁻, known as the conjugate base of the acid, and the hydrogen ion or proton, H⁺. The dissociation constant is usually written as a quotient of the equilibrium concentrations (in mol/L), denoted by [HA], [A⁻] and [H⁺]:

$${K}_{a} = \frac{[ {A}^{-} ] [ {H}^{+} ]}{[ HA ]}$$

The logarithmic constant, pKₐ, which is equal to −log₁₀Kₐ, is sometimes also referred to as an acid dissociation constant:

pKₐ=−log₁₀Kₐ

HLB:

Hydrophilic-Lipophilic Balance (HLB) values are calculated according to the widely used standard methodology contained in the following published article: “The HLB System”, 1987, ICI Americas Inc., Wilmington, Del., USA.

Method for Measuring CatSO3:

### Preparation Indicator Mixture (Acidified Solution):

The indicator mixture stock solution is made by dissolving 1 g of Disulphine Blue and 2 g of Dimidium Bromide in 50 g of alcohol, and adding 447 g of distilled water.
Once prepared the indicator mixture, then add 40 ml of indicator mixture-stock solution to a 2000 ml volumetric flask containing 200 ml of deionised water. Add 50 ml of sulphuric acid (2.5M), then add deionised water up to 2000 ml and assure appropriate mixing. The solution is stable for at least two months if stored in an amber bottle.

### Titration Procedure:

Place a 100 ml glass nessler tube on the magnetic stirrer using a retort stand for support. Holding the nessler tube at an angle, place a magnetic stir bar into the tube. Place a piece of white paper between the plate and the stirrer. This will make the “end point” easier to identify. Dispense 10 ml of indicator mix (acidified solution) in to the nessler tube. Turn on the magnetic stirrer. Dispense 10 ml of dichloromethane to the tube. Add 5 ml of sample solution to the tube. The layer of dichloromethane will turn red and the stirrer should be set so that this red layer is driven to the top of the solution. Titrate slowly until the red coloured layer disappears and the solution becomes a very pale grey.

Method for Measuring Viscosity:

The viscosity is measured by the following method, which generally represents the zero-shear viscosity (or zero-rate viscosity). Viscosity measurements are made with an AR2000 Controlled-Stress Rheometer (TA Instruments, New Castle, Del., U.S.A.), and accompanying software version 5.7.0. The instrument is outfitted with a 40 mm stainless steel parallel plate (TA Instruments catalog no. 511400.901) and Peltier plate (TA Instruments catalog no. 533230.901). The calibration is done in accordance with manufacturer recommendations. A refrigerated, circulating water bath set to 25° C. is attached to the Peltier plate.

Measurements are made on the instrument with the following procedures: Conditioning Step (pre-condition the sample) under “Settings” label, initial temperature: 25° C., pre-shear at 5.0 s⁻¹ for 1 minute, equilibrate for 2 minutes; Flow-Step (measure viscosity) under “Test” Label, Test Type: “Steady State Flow”, Ramp: “shear rate 1/s” from 0.001 s⁻¹ and 1000 s⁻¹, Mode: “Log”, Points per Decade: 15, Temperate: 25° C., Percentage Tolerance: 5, Consecutive with Tolerance: 3, Maximum Point Time: 45 sec, Gap set to 1000 micrometers, Stress-Sweep Step is not checked; Post-Experiment Step under “Settings” label; Set temperature: 25° C.

More than 1.25 ml of the test sample of the component to be measured is dispensed through a pipette on to the center of the Peltier plate. The 40 mm plate is slowly lowered to 1100 micrometers, and the excess sample is trimmed away from the edge of the plate with a rubber policeman trimming tool or equivalent. Lower the plate to 1000 micrometers (gap setting) prior to collecting the data.

Discard any data points collected with an applied rotor torque of less than 1 micro-N·m (e.g. discard data less than ten-fold the minimum torque specification). Create a plot of viscosity versus shear rate on a log-log scale. These plotted data points are analyzed in one of three ways to determine the viscosity value:

first, if the plot indicates that the sample is Newtonian, in that all viscosity values fall on a plateau within +/−20% of the viscosity value measured closest to 1 micro-N·m, then the viscosity is determined by fitting the ‘Newtonian’ fit model in the software to all the remaining data;

second, if the plot reveals a plateau in which the viscosity does not change by +/−20% at low shear rates and a sharp, nearly-linear decrease in viscosity in excess of the +/−20% at higher shear rates, then the viscosity is determined by applying the “Best Fit Using Viscosity vs. Rate” option from the “Analysis Toolbar”;

third, if the plot indicates that the sample is only shear-thinning, in that there is only a sharp, nearly-linear decrease in viscosity, then the material is characterized by a viscosity which is taken as the largest viscosity in the plotted data, generally a viscosity measured close to 1 micro-N·m of applied torque.

Report the average value of the replicates as the viscosity of the component, in units of Pa·s.

### EXAMPLES

### Example 1

The following samples are prepared by the processes described below. Sample 2 is in accordance with the present invention. Sample 1 is a comparison example where the solid lipid particle is not coated with a polymer.

| | Sample 1 | |
|---|---|---|
| | Comparison | Sample 2 |
| | example (no | In accordance with |
| Ingredients | polymer) | the present invention |
| LAS flakes (92% | 27.0 g | 27.0 g |
| active) | | |
| Dodecanoic acid | 66.0 g | 66.0 g |
| Silicone | 7.0 g | 7.0 g |
| Polymer | 0.0 g | 5.0 g |

### Process of Making the Samples:

### Process of Making Sample 1 (Comparison Example, No Polymer):

66.0 g of dodecanoic acid is placed in a plastic container in an oven at 50° C. (above its melting point of 43.2° C.). A stirrer blade is warmed in the oven at 50° C. for at least one hour and then the blade is placed and locked in an overhead stirrer. 7.0 g of silicone (PDMS) is added to the overhead stirrer and the mixture is stirred at 50° C. at 1000 rpm for 5 minutes. 27.0 g LAS flakes are added and the mixture stirred at 50° C., 350 rpm for 5 minutes to form a homogeneous mixture. This mixture is placed in a pressurized gun to form small extruded solid particles of 100 to 200 microns.
Process of Making Sample 2 (in Accordance with the Present Invention):
66.0 g of dodecanoic acid is placed in a plastic container in an oven at 50° C. (above its melting point of 43.2° C.). A stirrer blade is warmed in the oven at 50° C. for at least one hour and then the blade is placed and locked in an overhead stirrer. 7.0 g of silicone (PDMS) is added to the overhead stirrer and the mixture is stirred at 50° C. at 1000 rpm for 5 minutes. 27.0 g LAS flakes are added and the mixture stirred at 50° C., 350 rpm for 5 minutes to form a homogeneous mixture. This mixture is placed in a pressurized gun to form small extruded solid particles of 100 to 200 microns. The solid lipid particles are coated with 5 g of a polymer via spray-drying equipment.

### Test Protocol:

Each of the above described samples 1 and 2 were tested for matrix compatibility in a heavy duty liquid products.

### Compatibility Test Protocol:

The samples were added into a laundry detergent (Ariel UK liquid laundry detergent). We have measured the release of anionic surfactant in the matrix as increase of the CatSO3% versus the reference which is the Ariel UK liquid laundry detergent:

| | CatSO3% vs |
|---|---|
| | Reference |
| Sample 1 | +7 |
| Sample 2 | 0 |

Sample 2 (in accordance with the present invention) shows no difference in the surfactant concentration after 1 week of storage in the matrix product, instead sample 1 shows an increase of 7% in the CatSO3 suggesting a dissolution of the particles, which indicates a poor stability profile.
The samples were added into a laundry detergent (Ariel UK Water-soluble unit dose laundry detergent). We have measured the volume (V_{T}) occupied by the particles as the volume of the single particle multiplied by the number of particles (N*Vₙ) over 1 week time.

| | V_{T} | V_{T} |
|---|---|---|
| | (time 0 h) | (time 150 hours) |
| Sample 1 | 13 | 1.0 |
| Sample 2 | 13 | 6.0 |

Sample 2 (in accordance with the present invention) shows a smaller reduction of V_{T} than Sample 1. This suggests that Sample 2 has a superior compatibility with the matrix since the coating protects direct interaction between the core and the matrix within which is suspended, therefore we observe a smaller reduction of V_{T}.

### Example 2

### Illustrative Applications of the Detergent Composition

### Solid Free-Flowing Particulate Laundry Detergent Composition Examples:

| Ingredient | Amount (in wt %) |
|---|---|
| Core-shell particle of the present invention (e.g. | from 3 wt % to 30 wt % |
| sample 2) | |
| Anionic detersive surfactant (such as alkyl benzene | from 8 wt % to 15 wt % |
| sulphonate, alkyl ethoxylated sulphate and mixtures | |
| thereof) | |
| Non-ionic detersive surfactant (such as alkyl | from 0.5 wt % to 4 wt % |
| ethoxylated alcohol) | |
| Cationic detersive surfactant (such as quaternary | from 0 to 4 wt % |
| ammonium compounds) | |
| Other detersive surfactant (such as zwiterionic | from 0 wt % to 4 wt % |
| detersive surfactants, amphoteric surfactants and | |
| mixtures thereof) | |
| Carboxylate polymer (such as co-polymers of maleic | from 1 wt % to 4 wt % |
| acid and acrylic acid | |
| Polyethylene glycol polymer (such as a polyethylene | from 0.5 wt % to 4 wt % |
| glycol polymer comprising polyvinyl acetate side chains) | |
| Polyester soil release polymer (such as Repel-o-tex | from 0.1 to 2 wt % |
| and/or Texcare polymers) | |
| Cellulosic polymer (such as carboxymethyl cellulose, | from 0.5 wt % to 2 wt % |
| methyl cellulose and combinations thereof) | |
| Other polymer (such as care polymers) | from 0 wt % to 4 wt % |
| Zeolite builder and phosphate builder (such as zeolite | from 0 wt % to 4 wt % |
| 4A and/or sodium tripolyphosphate) | |
| Other co-builder (such as sodium citrate and/or citric | from 0 wt % to 3 wt % |
| acid) | |
| Carbonate salt (such as sodium carbonate and/or sodium | from 0 wt % to 15 wt % |
| bicarbonate) | |
| Silicate salt (such as sodium silicate) | from 0 wt % to 10 wt % |
| Filler (such as sodium sulphate and/or bio-fillers) | from 10 wt % to 50 wt % |
| Source of hydrogen peroxide (such as sodium | from 0 wt % to 20 wt % |
| percarbonate) | |
| Bleach activator (such as tetraacetylethylene diamine | from 0 wt % to 8 wt % |
| (TAED) and/or nonanoyloxybenzenesulphonate (NOBS)) | |
| Bleach catalyst (such as oxaziridinium-based bleach | from 0 wt % to 0.1 wt % |
| catalyst and/or transition metal bleach catalyst) | |
| Other bleach (such as reducing bleach and/or pre- | from 0 wt % to 10 wt % |
| formed peracid) | |
| Photobleach (such as zinc and/or aluminium | from 0 wt % to 0.1 wt % |
| sulphonated phthalocyanine) | |
| Chelant (such as ethylenediamine-N′N′-disuccinic acid | from 0.2 wt % to 1 wt % |
| (EDDS) and/or hydroxyethane diphosphonic acid | |
| (HEDP)) | |
| Hueing agent (such as direct violet 9, 66, 99, acid red 50, | from 0 wt % to 1 wt % |
| solvent violet 13 and any combination thereof) | |
| Brightener (C.I. fluorescent brightener 260 or C.I. | from 0.1 wt % to 0.4 wt % |
| fluorescent brightener 351) | |
| Protease (such as Savinase, Savinase Ultra, Purafect, FN3, | from 0.1 wt % to 0.4 wt % |
| FN4 and any combination thereof) | |
| Amylase (such as Termamyl, Termamyl ultra, Natalase, | from 0.05 wt % to 0.2 wt % |
| Optisize, Stainzyme, Stainzyme Plus and any combination | |
| thereof) | |
| Cellulase (such as Carezyme and/or Celluclean) | from 0.05 wt % to 0.2 wt % |
| Lipase (such as Lipex, Lipolex, Lipoclean and any | from 0.1 to 1 wt % |
| combination thereof) | |
| Other enzyme (such as xyloglucanase, cutinase, pectate | from 0 wt % to 2 wt % |
| lyase, mannanase, bleaching enzyme) | |
| Fabric softener (such as montmorillonite clay and/or | |
| polydimethylsiloxane (PDMS)) | |
| Flocculant (such as polyethylene oxide) | from 0 wt % to 1 wt % |
| Suds suppressor (such as silicone and/or fatty acid) | from 0 wt % to 0.1 wt % |
| Perfume (such as perfume microcapsule, spray-on | from 0.1 wt % to 1 wt % |
| perfume, starch encapsulated perfume accords, perfume | |
| loaded zeolite, and any combination thereof) | |
| Aesthetics (such as coloured soap rings and/or coloured | from 0 wt % to 1 wt % |
| speckles/noodles) | |
| Miscellaneous | Balance |

### Liquid Fabric Enhancer Composition:

| | | Liquid |
|---|---|---|
| Finished Product Material | | Fabric Enhancer |
| Chemical Name | Ingredient Function | w/w % |
| Core shell particle of the | Softener | From 3 to 10.00 |
| present invention (e.g. | | |
| sample 2) | | |
| Perfume microcapsules | Perfume encapsulate | 0.77 |
| acetoacetamide | Formaldehyde Scavenger | 0.04 |
| NaHEDP | Stabilizer/Chelant | 0.04 |
| Formic acid | Acidulant | 0.03 |
| CaCl2 34% | Rheology modifier | 0.02 |
| HCl 25% | Acidulant | 0.03 |
| Proxel GXL | Preservative | 0.04 |
| MP 10 antifoam | Suds suppressor | 0.10 |
| Dye | Dye | 0.28 |
| Perfume | Perfume | 0.54 |
| Rheovis CDE | Rheology modifier | 0.15 |
| DI water | Dilutant | Balance |
| | TOTAL | 100.00 |

### Liquid Laundry Detergent Composition:

| | (wt %) |
|---|---|
| AE3S⁴ | 2.6 |
| Alkyl benzene sulfonate³ | 7.5 |
| Sodium formate/Calcium formate | 0.4 |
| Sodium hydroxide | 3.7 |
| Monoethanolamine (MEA) | 0.3 |
| Diethylene glycol (DEG) | 0.8 |
| AE9⁶ | 0.4 |
| AE7⁵ | 4.4 |
| Polyetheramine¹¹ | — |
| Chelant⁷ | 0.3 |
| Citric Acid | 3.2 |
| C₁₂₋₁₈ Fatty Acid | 3.1 |
| Ethanol | 2.0 |
| Ethoxylated Polyethylenimine¹ | 1.5 |
| Amphiphilic polymer² | 0.5 |
| Core shell particle of the present invention | 3-10 |
| (e.g. sample 2) | |
| 1,2-Propanediol | 3.9 |
| Protease (40.6 mg active/g)⁹ | 0.6 |
| Amylase: Stainzyme ® (15 mg active/g)⁸ | 0.2 |
| Fluorescent Whitening Agents¹⁰ | 0.1 |
| Water, perfume, dyes & other components | Balance |

¹Polyethyleneimine (MW = 600) with 20 ethoxylate groups per —NH.
²Random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.
³Linear alkylbenzenesulfonate having an average aliphatic carbon chain length C₁₁-C₁₂ supplied by Stepan, Northfield, Illinois, USA
⁴AE3S is C₁₂₋₁₅ alkyl ethoxy (3) sulfate supplied by Stepan, Northfield, Illinois, USA
⁵AE7 is C₁₂₋₁₅ alcohol ethoxylate, with an average degree of ethoxylation of 7, supplied by Huntsman, Salt Lake City, Utah, USA
⁶AE9 is C₁₂₋₁₃ alcohol ethoxylate, with an average degree of ethoxylation of 9, supplied by Huntsman, Salt Lake City, Utah, USA
⁷Suitable chelants are, for example, diethylenetetraamine pentaacetic acid (DTPA) supplied by Dow Chemical, Midland, Michigan, USA or Hydroxyethane di phosphonate (HEDP) supplied by Solutia, St Louis, Missouri, USA Bagsvaerd, Denmark
⁸Savinase ®, Natalase ®, Stainzyme ®, Lipex ®, Celluclean ™, Mannaway ® and Whitezyme ® are all products of Novozymes, Bagsvaerd, Denmark.
⁹Proteases may be supplied by Genencor International, Palo Alto, California, USA (e.g. Purafect Prime ®) or by Novozymes, Bagsvaerd, Denmark (e.g. Liquanase ®, Coronase ®).
¹⁰Suitable Fluorescent Whitening Agents are for example, Tinopal ® AMS, Tinopal ® CBS-X, Sulphonated zinc phthalocyanine Ciba Specialty Chemicals, Basel, Switzerland
¹¹Polyetheramine of Example 1, 1 mol 2-Butyl-2-ethyl-1,3-propane diol + 4 mol propylene oxide/OH, aminated.

### Water-Soluble Unit Dose Laundry Detergent Pouch Composition:

| | | | | 2 com- | | | | |
|---|---|---|---|---|---|---|---|---|
| | 3 compartments | | | partments | | 3 compartments | | |
| | Compartment # | | | | | | | |
| | 1 | 2 | 3 | 1 | 2 | 1 | 2 | 3 |
| | Dosage (g) | | | | | | | |
| | 34.0 | 3.5 | 3.5 | 30.0 | 5.0 | 25.0 | 1.5 | 4.0 |
| Ingredients | Weight % | | | | | | | |
| Alkylbenzene | 20.0 | 20.0 | 20.0 | 10.0 | 20.0 | 20.0 | | |
| sulfonic acid | | | | | | | | |
| Alkyl sulfate | | | | 2.0 | | | | |
| C12-14 alkyl 7- | 17.0 | 17.0 | 17.0 | | 17.0 | 17.0 | | |
| ethoxylate | | | | | | | | |
| Cationic surfactant | | | | 1.0 | | | | |
| Zeolite A | | | | 10.0 | | | | |
| C12-18 Fatty acid | 13.0 | 13.0 | 13.0 | | 18.0 | 18.0 | | |
| Sodium acetate | | | | 4.0 | | | | |
| Enzymes | 0-3 | 0-3 | 0-3 | 0-3 | | 0-3 | | |
| Sodium | | | | 11.0 | | | | |
| Percarbonate | | | | | | | | |
| TAED | | | | 4.0 | | | | |
| Organic catalyst¹ | | | | 1.0 | | | | |
| PAP granule² | | | | | | | | 50 |
| Polycarboxylate | | | | 1.0 | | | | |
| Core shell particle | | | From | | From | From | | |
| of the present | | | 3 to 10 | | 3 to 10 | 3 to 10 | | |
| invention (e.g. sample 2) | | | | | | | | |
| Hydroxyethane | 0.6 | 0.6 | 0.6 | 0.5 | | | | |
| diphosphonic acid | | | | | | | | |
| Ethylene diamine | | | | | | 0.4 | | |
| tetra(methylene | | | | | | | | |
| phosphonic) acid | | | | | | | | |
| Brightener | 0.2 | 0.2 | 0.2 | 0.3 | | 0.3 | | |
| Alkoxylated | 5.0 | | | | 4.0 | 7.0 | | |
| polyamine⁶ | | | | | | | | |
| Hueing dye⁴ | | | 0.05 | | 0.035 | | 0.12 | |
| Perfume | 1.7 | 1.7 | | 0.6 | | 1.5 | | |
| Water | 10.0 | 10.0 | From | | 4.1 | 1.0 | | |
| | | | 7 to 0 | | | | | |
| Glycerol | 5.0 | | | | | 6.0 | 10.0 | |
| Sorbitol | | | | | 1 | | | |
| Propane diol | 5.0 | 5.0 | 5.0 | | From | From | 89.0 | |
| | | | | | 27 to | 8 to 1 | | |
| | | | | | 20 | | | |

| | |
|---|---|
| Buffers (sodium | To pH 8.0 for liquids |
| carbonate, | To RA >5.0 for powders |
| monoethanolamine)⁵ | |
| Minors | To 100% |
| (antioxidant, | |
| aesthetics, . . . ), | |
| sodium sulfate for | |
| powders | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising a core-shell particle, wherein the core-shell particle comprises a core, wherein the core comprises at least 50% by weight of the core of a mixture of silicone and fatty acid, wherein the core-shell particle comprise a shell, wherein the shell comprises at least 66% by weight of the shell of a polymer.

2. A composition according to claim 1, wherein the core-shell particle comprises from 90 wt % to 98 wt % core and from 2 wt % to 10 wt % shell.

3. A composition according to claim 1, wherein the weight ratio of fatty acid to silicone present in the core is in the range of from 5:1 to 15:1.

4. A composition according to claim 1, wherein the core-shell particle comprises at least 10% by weight of the core of detersive surfactant.

5. A composition according to claim 4, wherein the detersive surfactant is selected from alkyl benzene sulphonate, alkyl alkoxylated alcohol, alkyl alkoxylated sulphate, polyoxyethylene sorbitan monooleate and any combination thereof.

6. A composition according to claim 5, wherein the detersive surfactant is a C₁₂-C₁₆ alkyl ethoxylated alcohol having an average degree of ethoxylation of from 3 to 7.

7. A composition according to claim 1, wherein the fatty acid is C₁₀-C₁₆ alkyl fatty acid.

8. A composition according to claim 1, wherein the silicone has a structure selected from: 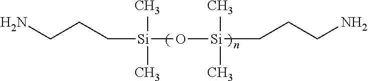
wherein n is in the range of from 200 to 300;
or 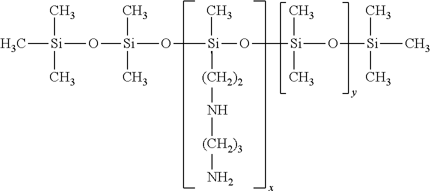
wherein X is from 1 to 5, and wherein Y is from 200 to 700.

9. A composition according to claim 1, wherein the polymer is selected from polyethylene glycol and derivatives thereof, polyethyleneimine and derivatives thereof, polyvinyl pyrolidone and derivatives thereof, polyvinyl alcohol and derivatives thereof, cellulosic polymer, and any combination thereof.

10. A composition according to claim 8, wherein the polymer has the structure:

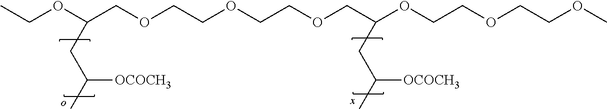

11. A composition according to claim 9, wherein the polymer has an alkoxylated polyethylene imine polymer having a weight average molecular weight in the range of from 300 Da to 1,000 Da, and wherein the polymer comprises an ethoxy and/or propoxy chain having from 12 to 36 alkoxy moieties.

12. A composition according to claim 1, wherein the core comprises at least 5% by weight of the core of perfume.

13. A composition according to claim 1, wherein the composition is a laundry detergent powder, wherein the laundry detergent powder comprises from 3 wt % to 30 wt % core-shell particle and from 33 wt % to 97 wt % detergent particle, and optionally wherein the detergent particle comprises a polymer which has the same chemical structure as the polymer comprised in the shell of the core-shell particle.

14. A composition according to claim 1, wherein the composition is a liquid laundry detergent composition, wherein the liquid laundry detergent composition comprises from 3 wt % to 10 wt % core-shell particle and from 90 wt % to 97 wt % liquid detergent matrix, wherein the core-shell particle is suspended within a continuous phase of liquid detergent matrix, and wherein the liquid detergent matrix comprises at least 1% by weight of the liquid detergent matrix of a polymer which has the same chemical structure as the polymer comprised in the shell of the core-shell particle, and optionally wherein the liquid detergent matrix comprises less than 30% by weight of the liquid detergent matrix of water.

15. A composition according to claim 1, wherein the composition is a water-soluble unit dose laundry detergent pouch.

16. A water-soluble unit dose laundry detergent pouch according to claim 15, wherein the laundry detergent pouch comprising at least two separate compartments, wherein the first compartment comprises the core-shell particle, and wherein the first compartment has a pH in the range of from 3.0 to 7.0, and wherein the second compartment comprises a detergent ingredient, and wherein the second compartment has a pH in the range of from greater than 7.0 to 12.0.

17. A water-soluble laundry detergent pouch according to claim 16, wherein the first compartment has a pH in the range of from 4.0 to 6.0, and wherein the second compartment has a pH in the range of from greater than 7.0 to 11.0.

18. A water-soluble laundry detergent pouch according to claim 15, wherein the first compartment comprises from 15% to 25% by weight of the core surfactant and from 2% to 5% of the polymer present in the first compartment, of the core-shell particle, and wherein the second compartment comprises from 15% to 35% of surfactant, from 50% to 70% of fatty amphiphile and polymer coating from 2% to 10% by weight of ingredients present in the second compartment.

19. A process of making a composition according to claim 1, wherein the process comprises the steps of:
(a) contacting a silicone with molten fatty acid to form a mixture of silicone and fatty acid;
(b) optionally contacting the silicone with a detersive surfactant and/or perfume; and
(c) coating this mixture with a polymer to form a core-shell particle; and
(d) incorporating the core-shell particle formed in step (c) into a detergent composition.

20. A process according to claim 19, wherein silicone is contacted with perfume prior to contacting the silicone with fatty acid.

21. A process according to claim 19, wherein the core is extruded prior to coating step (c).

22. A process according to claim 19, wherein the fatty acid is cooled to a temperature below its melting point prior to step (c).
